(19) United States
(12) Patent Application Publication
(10) Pub. No.: US 2004/0256866 A1
(43) Pub. Date: Dec. 23, 2004

(54) Straddling doorstop with upright

(76) Inventor: Robert F. Deming JR., New York, NY (US)

Correspondence Address: MUSERLIAN, LUCAS AND MERCANTI, LLP, 475 PARK AVENUE SOUTH, 15TH FLOOR, NEW YORK, NY, 10016, US

(21) Appl. No.: 10/870,125

(22) Filed: Jun. 17, 2004

Related U.S. Application Data
(60) Provisional application No. 60/479,133, filed on Jun. 17, 2003.

(51) Int. Cl. E05C 17/54

(52) U.S. Cl. 292/343

(57) ABSTRACT

An improvement for a doorstop is comprised of a structure including a base piece with a suitable cove in at least one side of the body of the base to straddle the end of the door at the bottom of said door, an upright with a shape suitable for grasping and visibility from both sides of a door affixed to the base, and suitable and properly distributed weight such that said structure stands adjacent to the end of an open door and holds said door in place.

### BACKGROUND OF THE INVENTION

1. Field of the Invention

The present invention relates to a structure for a doorstop which stands at the end of an ajar door—visible from both sides of the door. When in use, the prominent structure is easily reachable, with a vertical component joined to a coved or dual-pronged, weighted base, which straddles the end of the door while remaining structurally independent from the door. The high profile, stop can be reached easily and reset, equally and conveniently, from either side of the door in conjunction with swinging the door to its new position.

2. Art Relating to the Invention

Doorstops since the inception of door use have come in a myriad of shapes. There are two main types of doorstops—those which jamb a door from underneath, and those which rely on weight and form to stop the door from swinging.

The stops which jamb a door are generally made of rubber or a synthetic and are sloped in shape so as to compress under the door. They are compressed under the door generally from a person's effort relating to one side of the door. The person holds the stop in place and pushes the door against the slope of the doorstop. The underside of the door catches on the pliable surface of the stop and jambs the door in place. This type of stop is not easily seen from both sides of the door and is very low profile. Indeed, it can create a bit of a surprise to those perceiving that the door is freely ajar and ready to swing easily. To reposition this type of doorstop a person can find themselves having to contort if the stop is to be released or applied on the opposite side of the door.

The weighted and formed stops are generally low in profile and are formed into all types of familiar shapes. often some indent in the form allows the user to corner the door and use the weight of the figure to hold or stop the door from swinging.

Other stops—configured to hold away the back vertical, hinged end of the door away from the doorjamb—are also used. These doorstops often have an attachment feature such as being magnetic to be affixed to a hinge or a series of tightening brackets and plates which are adjustable and hold the stop in place.

Whatever the apparatus the stops are generally easier to operated and are more obvious from one side of the door relative to the other. Indeed the door itself is generally more easily freed from one side via a breeze or a push from one side of the door in comparison to the other.

The able bodied person has managed generally to maneuver the doorstops in wide use today. However, while the limitations of the current group of choices may be inconvenient to the average user, those limitations can offer one more obstacle to people with back and leg problems, the handicapped, the elderly, the seeing impaired, the wheelchair bound, the arthritic and even those who are physically or mentally hampered (such as a stroke victim). While coordination, caution, perception and acumen are a taken-for-granted means to overcome the limitations of the current set of doorstops, that may not be enough for many other users who use doorstops.

### SUMMARY OF THE INVENTION

The present invention comprises a weighted base which straddles the end of the door with a cove that has sides which are either equilateral or uneven in their length and girth. The cove is wide enough to straddle the door at least to sit around the angles of the door or to keep it from swinging loose. The apparatus is free standing such that it can be set aside when not in use and easily set and reset when in use.

The present invention is comprised of components—including the coved base and an upright. A handle on the upright can be added. If necessary, attachment hardware is employed. Indeed the present invention can be a single formed, cast or molded unit. The resent invention can be assembled from components such as the base piece, the upright and the handle. The handle aspect per sé may not be formed or attached or differentiated from the upright depending on the style and design of the apparatus. If a handle is designed into the apparatus it may have the appearance of any number of finials, orbs, animal heads, product shapes, functional shapes, architectural shapes, handles or suitable forms.

The upright portion of the apparatus may be a simple pole structure or it may incorporate architectural, natural or functional designs. Designs can include vines, leaves, architectural columns, a golf club, lattice, animal shapes, shapes that match furniture or houseware designs, artistic, branding iron, antiqued or distressed, basic rods, or poles which are wider in one portion and narrower in other portions of the upright. The upright may include a cove shaped guide which can help hold the overall structure more in alignment with to vertical component of the door.

The base portion of the apparatus may be a simple U-shape, or it may incorporate architectural, natural or functional designs. Designs can include letters of the alphabet, numbers, symbols, the base portion of a hockey stick or a golf club, sculpture, animal shapes, vehicles, shapes that match furniture or houseware designs, artistic creations, branding iron symbols, tools, equipment, money, royal, very modern, natural, music, cultural, antiqued or distressed, etc. The cove, of the base, can be wider or longer on one side and narrower or shorter on the other side of the opening.

Each component of the present invention can be made of various materials. Steel, stainless steel, wood, plastic, leather, iron (cast or wrought), aluminum, alloys, brass, pewter or any suitable material can be used to construct the apparatus. Coatings, paint and chemical processes may be used to decorate or protect the invention from corrosion, wear, or from affecting the quality and surfaces with which the apparatus may be in contact—such as the door veneer, wall paint, carpet color, etc.

The present invention may be constructed so as to be rigid or it may have a hinged, swivel component wherein the base and upright pivot.

While there are a multitude of possible permutations, the preferred embodiment of the invention includes a coved base, an upright with a suitable shape to grasp the upright such as a handle and suitable weight distributed appropriately—toward the base or in the base. The overall weight of the present invention should range between 3 lbs. to 10 lbs., depending on the size of the door to be held. For instance a large entry door on a Spanish Mission style home in the windy Southwest would require a heavier doorstop than a door in an apartment occupied by an elderly person in New York City.

The heights of the present invention can vary from 6″ to 36″ as long as there is an upright component affixed to a base which straddles the bottom of the swinging end of the door. The present invention can be coated particularly at the base to prevent rust, corrosion, and marring of the door wall or base board. In addition, coatings at the base such as a rubber coating may should serve to add grip to the apparatus relative to the floor or door base.

Legs, pads, or a cleat surface on the base may be incorporated to help the apparatus remain in the position where it is placed.

Under the preferred embodiment a myriad of adjoined component and base configurations are possible using various attachment techniques, the most likely configuration is constructed to have an upright and wrap the end of a door at the base.

### BRIEF DESCRIPTION OF THE DRAWINGS

These and other aspects of the present invention may be more fully understood with reference to the drawings wherein:

FIG. 1 Shows one version of the invention.

FIG. 2 shows details of possible assembly and components aspects of the invention.

FIG. 3. shows a comparison between a purely functional version of the invention and a stylized version of the invention.

FIG. 4 shows the invention in use.

FIG. 5 shows several versions of the invention from overhead as the particular version relates to the end of the door when in use.

FIG. 6 shows a representative version of the invention in use with a guide on the upright.

FIG. 7 shows representative varying heights of the present invention.

FIG. 8 shows a few stylized representative versions of the invention.

FIG. 9 shows views of a few stylized representative variations of the invention including additional components.

FIG. 10 shows views of a few representative, architectural variations of the base of the invention.

FIG. 11 shows views of a few representative, architectural variations of the of the invention including a stylized upright and base.

FIG. 12 shows a version of the present invention with a swivel connection between the base and the upright.

### DETAILED DESCRIPTION OF THE INVENTION

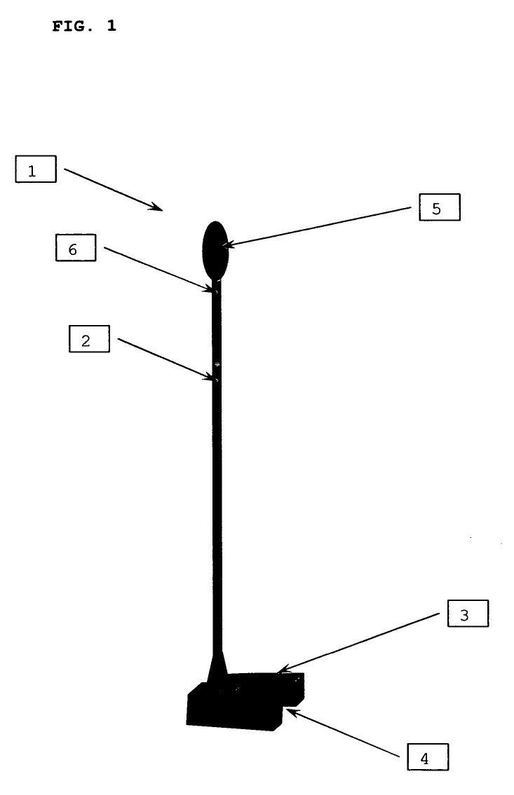

The preferred embodiment of the present invention is a single, handled, prominent, end-of-door, base-straddling doorstop. This structure is to be used in direct conjunction with known and understood needs of those wishing to hold a door ajar in a designated position. Referring now to FIG. 1 Illustrates the invention as a cast structure 1. The casting material is any suitable metal such as aluminum or cast-iron or steel. The structure includes an upright 2 the base 3 with a coved opening 4 and a knob 5 at the top of the upright to create a handle wider than that which can be used as a handle—the top of the upright 6 itself.

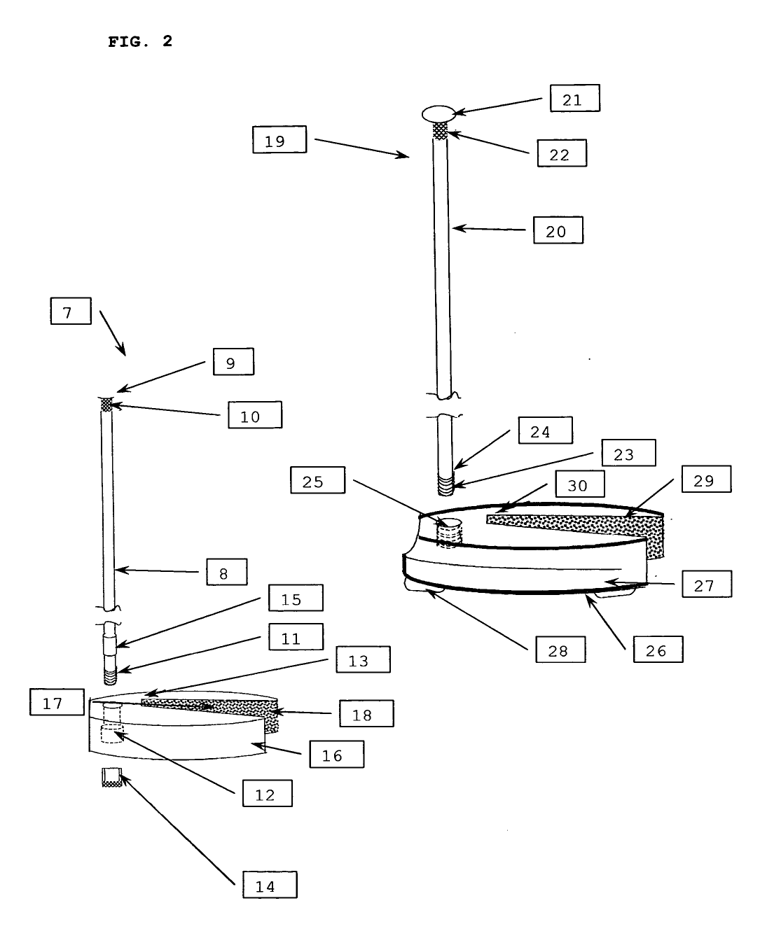

FIG. 2 shows possible details of assembly and components of the invention. Structure 7 is comprised of an upright 8 with no added knob for grasping at the top 9 of the upright. There is attached a glow-in-the-dark reflector band 10 toward the top of the upright for night visibility. The upright is threaded on one end 11 to pass through a hole 12 in the base structure 13 where the upright is screwed to a nut 14. A washer 15, or widened cast is used above the base to help hold the base. The base 16 has sufficient weight to hold the door and to sufficiently hold the upright up. The base includes the coved opening 17 with a wider mouth 18 which narrows to the back.

Structure 19 is comprised of an upright 20 with a knob for a handle 21. The glow-in-the-dark strip 22, while not absolutely necessary, is attached just under the knob. Again the upright is threaded 23 at the base 24, but screws 25 directly into the base. A coating 26 is used on the bottom and sides 27 of the base to protect surfaces where the invention is used. The base has affixed pads 28 to help set the stop in place. The cove opening 29 of the base has a suitable coating 30 on the surface to protect the door from marring.

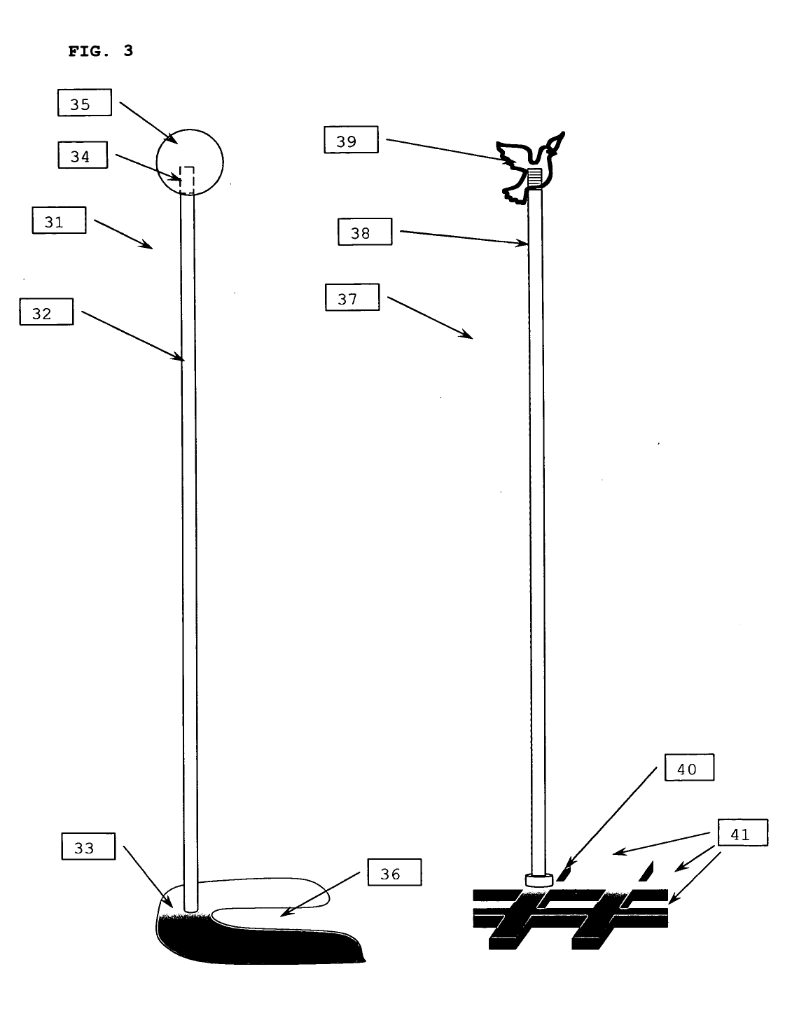

FIG. 3. shows a comparison of a purely functional version of the invention and a stylized version of the invention. Structure 31 represents a functional version of the invention, it does not include a glow-in-the-dark reflector strip. It does, however include the upright 32 attached to base 33. The upright is adhered 34 the knob handle 35 at the top. The base of structure 31 has a suitable coved opening 36 and appropriate weight and girth to hold a door. Structure 37 has an upright 38 screwed to a suitable finial 39. The base 40 is representative of a plurality of possible shapes that can serve as a suitable shape for the base. The base, in this illustration, has more than one coved side 41 which can serve to straddle the end of a door. Similarly, when in use, the upright of the present invention does not have to line up exactly on-center with the vertical end of the door.

The components of the present invention, as well as the construction and assembly techniques and the design aesthetic features of the invention are interchangeable with one another. A plurality of variations of the present invention can be achieved to constitute a suitable permutation of the final structure. The components and assembly techniques and designs of the present invention are mutually exclusive, as to their necessity to each other, to construct the present invention.

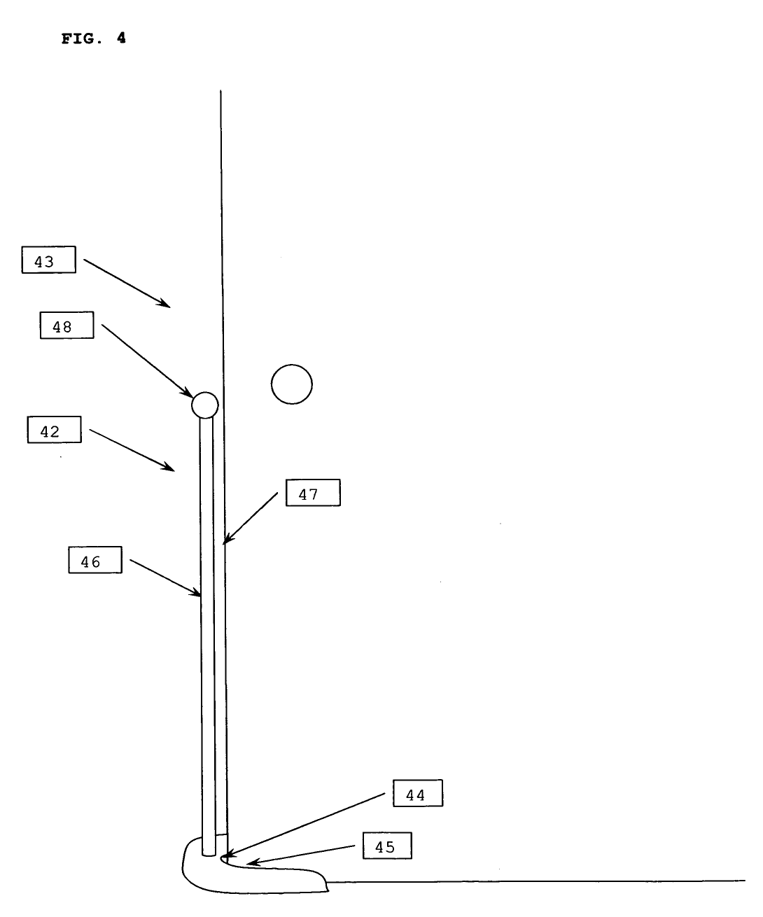

FIG. 4 illustrates the invention 42 in use and straddling a door 43. The coved base 44 wraps the base 45 of the ajar door. The structures upright 46 sits at the end 47 of the ajar door. The top of the upright, with a handle 48, is shown in proximity to the doorknob; however, there is no necessary relationship between the height of the structure's upright and the doorknob height.

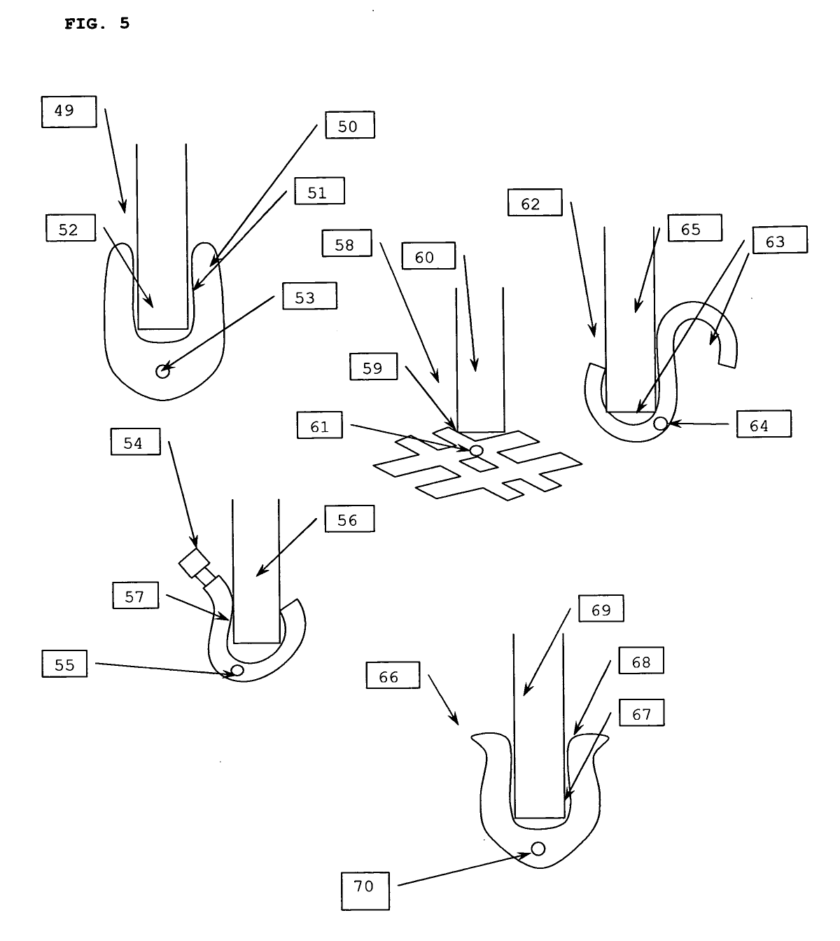

FIG. 5 illustrates how various representative base shapes straddle the door. Structure 49 has dual prongs 50 which create a cove 51 that surrounds the base of the door 52. The upright is located at opening 53. Structure 54 illustrates how the upright 55 of the present invention can be located off-center relative to the end of the door 56. The shape of structure 54 creates a coved opening 57 to wrap the end of the door. Structure 58 shows how a minimal cove 59 can be utilized as part of the present invention to straddle the door 60. Location 61 is one place where the upright can be attached or incorporated. Structure 62 shows how more than one cove 63 can be part of the base. The upright is affixed at location 64—slightly off-center relative to the end of the door 65. Structure 66 illustrates a coved opening 67 which incorporates a widened mouth 68 to help sleeve the door 69 when the user is setting the apparatus. The upright is on-center 70 relative to the door end.

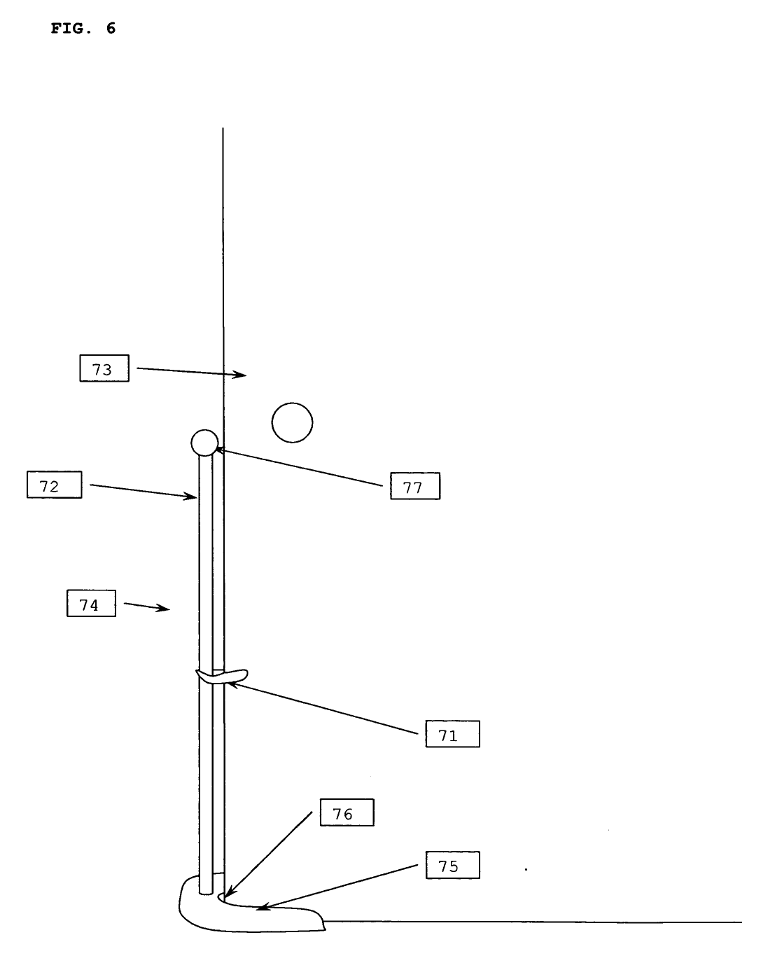

FIG. 6 illustrates how a guide 71 positioned on the upright 72 can wrap the end of the door 73 to help situate to overall structure 74 in an position. Base 75 proves the means to stop the door by straddling the door base 76. A knob handle 77, while not required, is provided for help in grasping the present invention when setting, resetting and setting aside.

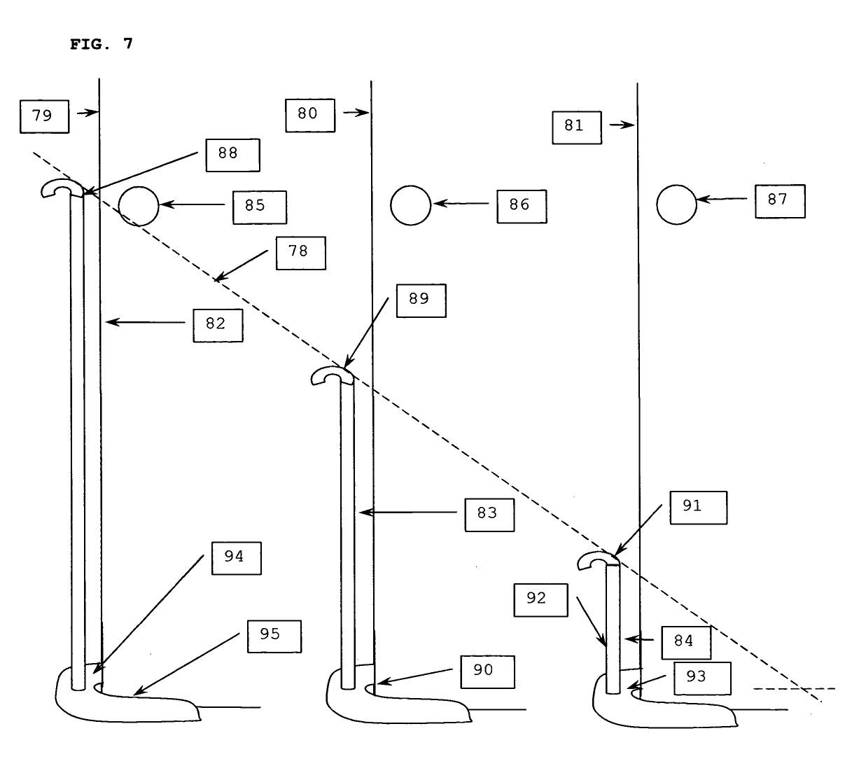

FIG. 7 shows a continuum of the possible heights, represented by the dotted line 78 of the present invention as it relates to the ends of the doors 79, 80, 81 shown at consistent height. The representative structures 82, 83, 84 show varying heights as the apparatus relates to the doorknob 85, 86, 87. The first structure 82 has a finial handle 88 affixed above the elevation of the knob 85. The middle structure 83 has the finial handle 89 affixed approximately midway between the doorknob 86 and the base 90. The third structure 84 has the finial 91, affixed to the upright 92, at an elevation relatively short in comparison to the knob 87. The base 93 of the third structure 84 supports the upright 92 and holds the door 81 at it's base. Similarly, the base 94 of the first tallest structure creates a cove 95 to wrap the door at any ajar position. While three representative structures are shown, a continuous plurality of suitable heights, represented by dotted line 78 can be utilized to construct the present invention.

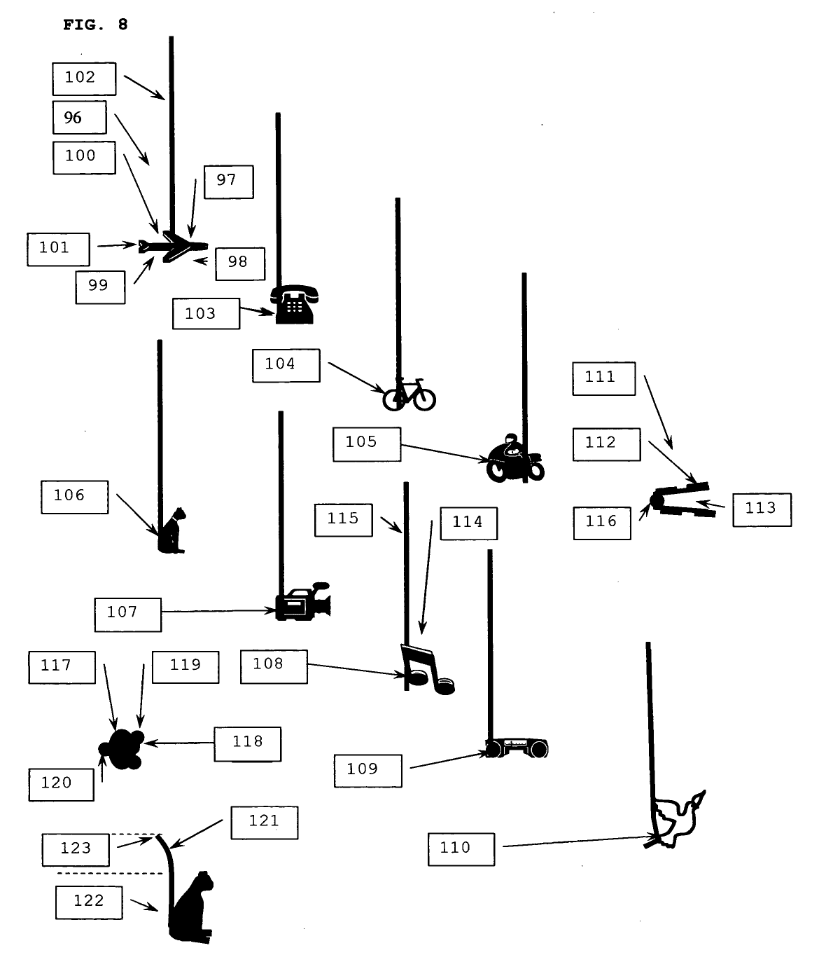

The illustrations of FIG. 8. show how the present invention can be constructed to utilize a plurality of shapes for the base. The shape at the base has at least one minimal cove component or the shape is modified or duplicated to create a cove to suit the construction of the present invention. Structure 96 has affixed a shape 97 with several possible coves 98, 99, 100; even the cove 101 can serve to hold the door at the base. While the base is somewhat complex, the upright 102—as with all the uprights of this illustration—is a simple post of any suitable height and no knob or finial is affixed to these representative structures of the present invention. Bases 103, 104, 105, 106, 107, 108, 109, 110—as with a myriad of shapes—can be affixed to an upright to create a variety of permutations of the present invention.

Structure 111 is an overhead view of base 108 with a music note theme. The prongs 112 of structure 111 that create the cove 113 are a doubling of the shape 114. The upright 115 is affixed at area 116 of structure 111. Structure 117 is the overhead view of base structure 106. Here the cove 118 of the base is created by the cat's paws 119. The tail area 120 of the cat serves as the start of the upright. Indeed the cat's tail 121 of structure 122 with an exaggerated length 123 can serve as the upright of the present invention. Illustrated with structures 106, 117, 122 is that the present invention can be comprised of a myriad of possible uprights and suitably weighted bases, with at least one suitably sized cove to straddle the base of the door.

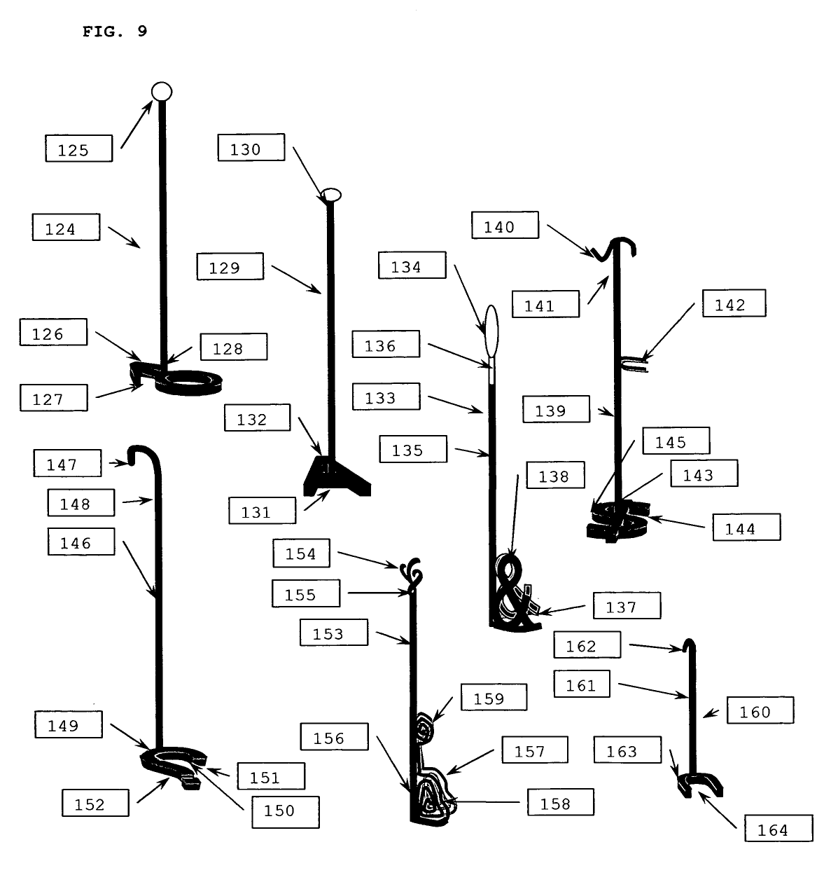

FIG. 9 shows views of a few representative variations of the present invention with a variety of additional components. Structure 124 has a orb handle 125; while the symbol base 126 has at least two coves 127, 128. Structure 129 has a flattened orb handle 130 and one cove 131 at the base 132. Structure 133 has an elongated handle 134 at the top of the upright 135 with a glow-in-the-dark reflector strip 136 affixed just under the knob. The cove base 137 of structure 133 is created by duplicating character 138.

Structure 139 has an ergonomic handle 140 at the top of upright 141. Along the upright is affixed a guide 142 to stabilize the lateral rocking of the upright. The base 143 of structure 139 has at least two coves 144, 145 to straddle the door base. Structure 146 has a hooked handle 147 at the top of the upright 148. Base 149 is comprised of one apparent cove opening 150. However, two other coved locations 151, 152 on the base can be used to trap the end of the door. Structure 153 has a suitable finial handle 154 at the top of the upright 155. The base 156 is comprised of two pieces 157 of wrought iron artwork. Between the two pieces of wrought iron is the cove 158. The dual wrought iron continues up the upright to create a guide 159 for this structure, which adds lateral stability to the present invention. Structure 160 represents possible low rise functional designs of the present invention. The upright 161 rises to a height above approximately 6″. The handle is 162 is a simple hook shape. The base 163 is a simple U-shape which comprises the necessary cove 164 of the present invention.

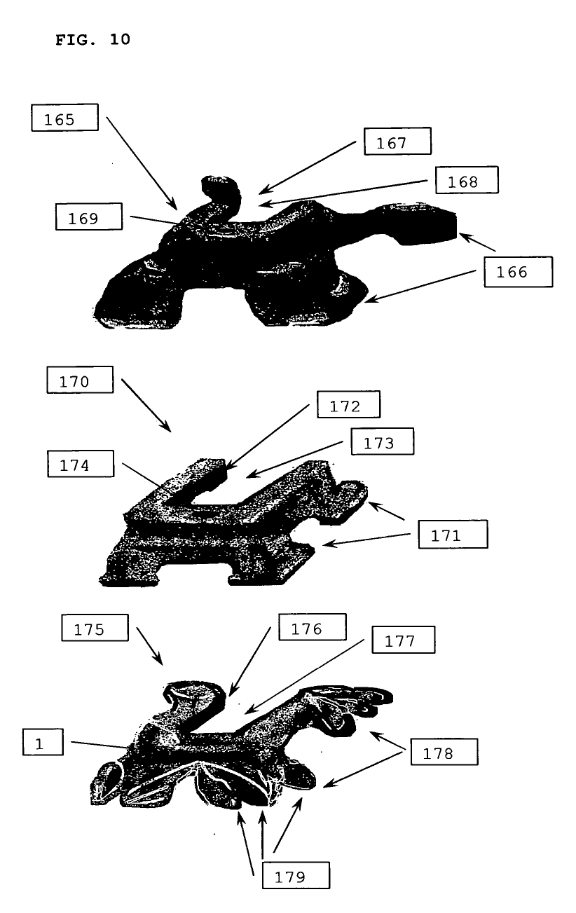

FIG. 10 shows a series bases without the upright attached. In that the base shape has at least one cove to straddle the end of the door and has suitable weight and can be seen and manipulated relatively equally from either side of the door, the structures comprise the method of the present invention. However, the preferred embodiment of the present invention includes at least a simple upright to be affixed to the base. Structure 165 has legs 166 and an exaggerated opening 167 to the cove 168. Area 169 is where an upright can be affixed. Structure 170, with legs 171 has linear walls 172 to create the cove 173 for the present invention. Hole 174 is where an upright can be affixed to structure 170. Structure 175 has a combination of a linear and rounded opening 176 to create the cove 177. Structure 175 has legs 178 with multiple feet 179 which can help grab the floor.

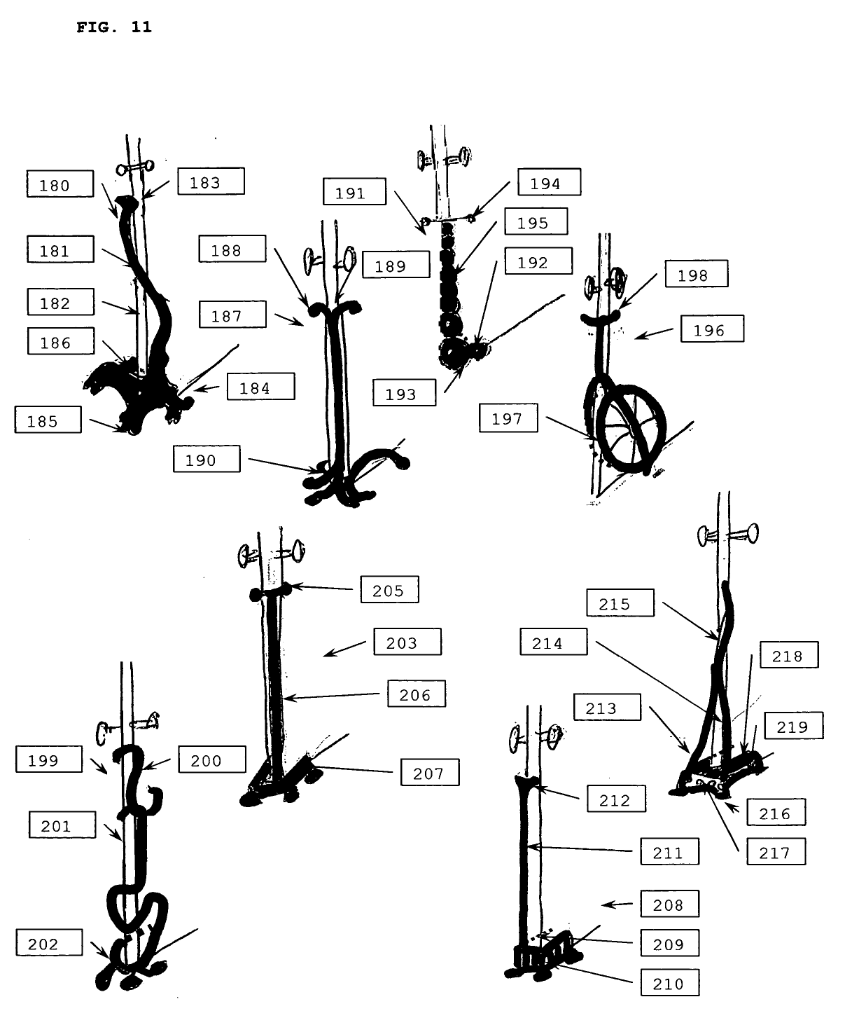

FIG. 11 illustrates a few representative designs where the key elements of the present invention are integrated with design themes that emphasize an inclusive model from top to bottom. Structure 180 has an organic theme where the upright 181 weaves up the side of the door 182. The widened top 183 of the upright creates a handle. The weaving upright 181 serves as the guide component; while the base 184, with legs 185 and cove 186 wraps the bottom of the ajar door. Structure 187 has a dual shaped handle 188 which creates the guide 189 of the structure. The design theme of structure 187 is consistent from the base 190 to the integrated handle 188. Structure 191 shows how a similar shape can constitute each element of the present invention. The prongs 192 of the base 193 are the same shape as the handles 194. The upright 195 is created by stacking the shape. Structure 196 has an overall design theme related to a familiar shape. Two wheel shapes 197 create the base to straddle the door. Handlebar shapes create the handle 198 for this permutation of the present invention.

Structure 199 shows a design theme where the upright 200 is made more functional by virtue of its elongated curve. The elongated theme of the handle is carried to the upright 201 and to the base 202 which wraps the door. Structure 203 has rounded end points at the base 204 and rounded points at the handle 205 that are combined with linear elements of the upright 206 and the walls of the coved base 207. Structure 208 has a base 209 with picket lattice walls 210. The upright 211 tapers out to create the handle 212. Structure has dual uprights 213, 214 that meet to create the handle 215. The base 216 has holes 217 in its walls. The base has linear sides 218 and an arched underside 219.

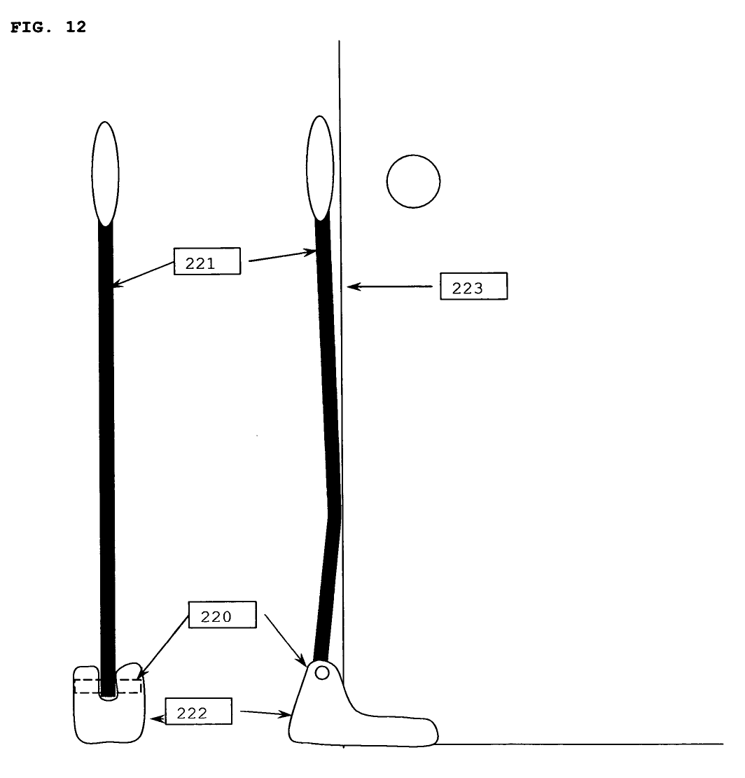

FIG. 12 shows two views of the present invention where a swivel connection 220 is made between the upright 221 and the base 222. When positioned against the door 223 the upright leans on the vertical end of the door.

What is claimed is:

1. A method and structure to stop a door from swinging comprising:
(a) a structure with a sufficient girth in the base to rise to an elevation above the bottom of a door, and
(b) a base, which sits on the floor, with at least one coved component, and
(c) wherein the base's coved opening is sufficiently wide enough to straddle all or part of the end of a door at the door's base, and
(d) a suitable weight which is distributed suitably, and
(e) wherein the apparatus suitably stands in place when at the end of an ajar door.

2. The structure of claim 1 wherein the structure has an upright component.

3. The structure of claim 1 wherein the present invention's components are a cast single structure.

4. The structure of claim 1 wherein said structure is comprised of assembled components.

5. The structure of claim 1 wherein adjoining components are threaded and screwed together.

6. The structure of claim 1 wherein adjoining components twist-lock together.

7. The structure of claim 1 wherein components are joined by a unifying process.

8. The structure of claim 2 wherein a handle is attached to the top of the upright component.

9. The structure of claim 2 wherein a guide is attached at point along the upright component.

10. The structure of claim 2 wherein a visible glow-strip is attached at a point along the vertical component for nighttime visibility.

11. The structure of claim 1 where the structure is made of a suitable man-made material.

12. The structure of claim 1 where the structure is made of a combination of both natural and man made materials.

13. The structure of claim 1 wherein said structure can be adjoined from components by the end user.

14. The structure of claim 1 wherein adjoining component attachments are made with hardware.

15. The structure of claim 1 wherein a coating or paint is employed to coat any or all of the structure.

16. The structure of claim 1 wherein the relative widths of the inner walls of the base vary in order to hold the door.

17. The structure of claim 1 wherein a familiar shape, related to doorstops, comprises the configuration of the base.

18. The structure of claim 1 wherein a shape, not related to doorstops, comprises the configuration of the base.

19. The structure of claim 2 wherein a familiar shape, related to door hardware, comprises the configuration of the upright component.

20. The structure of claim 2 wherein a familiar shape, not related to door hardware, comprises the configuration of the upright component.

21. The structure of claim 2 wherein there is a swivel connection between the vertical upright component and the base.
